(19) United States
(12) Patent Application Publication
(10) Pub. No.: US 2008/0291371 A1
(43) Pub. Date: Nov. 27, 2008

(54) LIQUID CRYSTAL PANEL AND LIQUID CRYSTAL DISPLAY DEVICE

(75) Inventor: Hiroki Sato, Yokohama (JP)

Correspondence Address: CALFEE HALTER & GRISWOLD, LLP, 800 SUPERIOR AVENUE, SUITE 1400, CLEVELAND, OH, 44114, US

(73) Assignee: InfoVision Optoelectronics Holdings Limited, Road Town (VG)

(21) Appl. No.: 12/034,054

(22) Filed: Feb. 20, 2008

(30) Foreign Application Priority Data
Feb. 22, 2007 (JP) 2007-042821

(51) Int. Cl. G02F 1/1335; G02F 1/13

(52) U.S. Cl. 349/96; 349/179

(57) ABSTRACT

The object of the present invention is to provide a liquid crystal display device having high contrast and excellent viewing angle characteristic which can be manufactured without employing the phase compensation film and with low cost. The technical solution is to form a liquid crystal panel of an active matrix type liquid crystal display device having the following structure, that is, each of the pixels of said liquid crystal panel comprises liquid crystal layer, and said liquid crystal layer comprises a first orientation region in a first liquid crystal orientation direction and a second orientation region in a second liquid crystal orientation direction, furthermore, the difference between said first liquid crystal orientation direction and said second liquid crystal orientation direction is about 180 degrees, and the transmission axes of two polarizers, between which said liquid crystal layer is sandwiched, are perpendicular with each other, furthermore, angles of about 45 degrees are formed by the transmission axes of the two polarizers together with said first and second orientation directions.

### TECHNICAL FIELD

The present invention relates to a liquid crystal display device, in particular, relates to a liquid crystal display device having excellent viewing angle performance.

### BACKGROUND ART

Based on the requirement for saving the space and saving the electrical power, the liquid crystal display device has been used widely in a field centered by the personal computer display, and the like. Furthermore, in order to popularize the liquid crystal display device as a display device in a wide field, the features, such as the cost, the high contrast, and the rapid response speed, and the like, need to be improved.

The liquid crystal display of the said TN (twisted nematic) mode (Hereinafter also referred to as “TN type liquid crystal display”) has a low manufacturing cost so that it is used widely.

As disclosed in a Japan Patent which publication No. is JP2002-72209 (the patent Article 1), in such TN type liquid crystal display, two polarizers are employed and they are orthogonal with each other. Under a condition that the voltage is not applied to the liquid crystal layer (in normal state), the light of the backlight lamp is allowed to transmit to achieve a bright display (Normal white display). On the other hand, applying sufficient voltage on the liquid crystal layer to erect the liquid crystal molecules in a direction perpendicular with the substrate to release the twisted nematic state of TN liquid crystal, thereby the dark display is achieved; this is a state that the light does not polarize even though the light transmits through the liquid crystal layer.

However, even though sufficient voltage is applied to the liquid crystal layer, for those liquid crystal molecules near the alignment film, the behavior of the liquid crystal molecules is restricted (anchoring effect) due to the function of the oriented restriction force produced by the oriented process applied to the alignment film, even though the voltage is applied, the liquid crystal molecules cannot be oriented completely at the direction of the voltage, and it causes the problems, such as the decrease of the contrast and the reversion of the grey scale of the intermediate grey scale, and the problems, such as that the excellent viewing angle cannot be obtained and the reduction of the display quality, occur.

As a technical solution for solving these problems, the technical solution called multiple domains as recorded in the Patent Article 1 is usually adopted . . . .

### CONTENTS OF THE PRESENT INVENTION

However, for the technical solution as disclosed in the Patent Article 1, a phase compensation film is required to be used as a phase difference compensation element, which increases the number of the elements and the manufacturing cost.

Therefore, the object of the present invention is to provide a liquid crystal display device having excellent display quality which can be manufactured without the phase compensation film and with low cost, meanwhile, the liquid crystal display device provided here has a high contrast and excellent viewing angle characteristic.

The first aspect of the present invention provides a liquid crystal panel for an active matrix type liquid crystal display device, including the following structure, that is,

each of the pixels of said liquid crystal panel comprises a liquid crystal layer, and the liquid crystal layer comprises a first orientation region in a first liquid crystal orientation direction and a second orientation region in a second liquid crystal orientation direction,

the difference between said first liquid crystal orientation direction and said second liquid crystal orientation direction is about 180 degrees,

the transmission axes of the two polarizers, between which two polarizers of said liquid crystal layer is sandwiched, are perpendicular with each other, and angles of about 45 degrees are formed by the transmission axes of the polarizer and said first orientation direction and said second orientation direction.

The second aspect of the present invention provides a liquid crystal panel relating to the active matrix type liquid crystal display device of the first aspect of the present invention, wherein said liquid crystal layer is in a TN (twisted nematic) mode, that is, a twisted nematic liquid crystal mode.

The third aspect of the present invention provides an active matrix type liquid crystal display device including the liquid crystal panel as described according to the first aspect of the present invention or the second aspect of the present invention.

According to the present invention, the contrast and viewing angle characteristic will be improved even though the phase compensation film is not added to the prior liquid crystal panel. The result thereof will be described in detail in “Mode of carrying out the present invention” as described below.

### DESCRIPTION OF THE DRAWINGS

FIG. 1 is an exploded view illustrating the general structure of a pixel in an embodiment of the present invention.

FIG. 2 is a cross sectional view illustrating schematically an alignment state of the liquid crystal molecules when the voltage is applied to a sub-liquid crystal unit 100B and a sub-liquid crystal unit 100A.

FIG. 3 is a plan view illustrating that the liquid crystal molecule 103A1, liquid crystal molecule 103A9, and the liquid crystal molecules between the liquid crystal molecule 103A1 to 103A9 existing in the sub-liquid crystal unit 100A have their orientation twisted in turn under a condition that the voltage is not applied to the sub-liquid crystal unit 100A.

FIG. 4 is a plan view illustrating that the liquid crystal molecule 103B1, liquid crystal molecule 103B9, and the liquid crystal molecules between the liquid crystal molecule 103B1 to 103B9 existing in the sub-liquid crystal unit 100B are twistingly oriented in turn under a condition that the voltage is not applied to the sub-liquid crystal unit 100B.

FIG. 5 is a cross sectional view taken along the line Y-Y in FIG. 7 illustrating the liquid crystal molecules alignment state when it is observed transversely under a condition that sufficient voltage is applied to the sub-liquid crystal unit 100A.

FIG. 6 is a cross sectional view taken along the line X-X in FIG. 3.

FIG. 7 is a plan view illustrating the liquid crystal molecules alignment state under a condition that sufficient voltage is applied to the sub-liquid crystal unit 100A.

FIG. 8 is a graph illustrating the voltage applied to the pixels of the liquid crystal panel and the transmissivity of the light in an embodiment of the present invention.

FIG. 9 is a graph illustrating the relationship between the voltage applied to the pixels of the liquid crystal panel and the light transmissivity in the prior TN liquid crystal.

FIG. 10 is an illustration view for describing a general condition of a mask which is used under a condition that the orientation is performed on the alignment film at the sub-liquid crystal unit 100A side of the alignment film 106.

FIG. 11 is an illustration view for describing a general condition of a mask which is used under a condition that the orientation is performed on the alignment film at the sub-liquid crystal unit 100B side of the alignment film 106.

FIG. 12 is a graph illustrating the viewing angle characteristic of a liquid crystal panel having the prior pixel structure (TN liquid crystal).

FIG. 13 is a graph illustrating the viewing angle characteristic of a liquid crystal panel which is a liquid crystal panel having the prior pixel structure (TN liquid crystal) after being improved by utilizing a phase compensation film.

FIG. 14 is a graph illustrating the viewing angle characteristic of a liquid crystal panel having the pixel structure of the present invention.

### EXPLANATION OF THE SYMBOLS

100 liquid crystal unit corresponding to the respective pixel
100A sub-liquid crystal unit
100B sub-liquid crystal unit
101A an arrow illustrating the orientation direction applied to the sub-alignment film 104A
101B an arrow illustrating the orientation direction applied to the sub-alignment film 104B
103A1 liquid crystal molecule
103A9 liquid crystal molecule
103B1 liquid crystal molecule
103B9 liquid crystal molecule
104 alignment film
104A sub-alignment film
104B sub-alignment film
105 polarizer
106 alignment film
106A sub-alignment film
106B sub-alignment film
107 polarizer
108A an arrow illustrating the orientation direction applied to the sub-alignment film 106A
108B an arrow illustrating the orientation direction applied to the sub-alignment film 106B
110 an arrow indicating a direction of the transmission axis of the polarizer 105
111 an arrow indicating a direction of the transmission axis of the polarizer 107

### MODE OF CARRYING OUT THE PRESENT INVENTION

The embodiments of the present invention will now be described by referring to the drawings as follows.

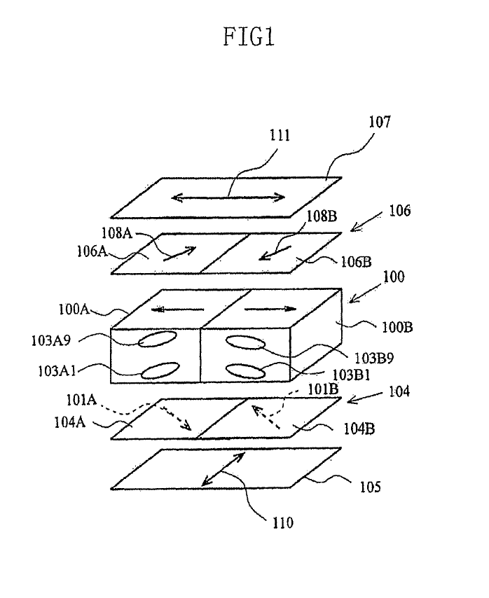

FIG. 1 is an exploded view illustrating the general structure of a pixel in an embodiment of the present invention.

In FIG. 1, 107 is a polarizer, 106 is an alignment film, 106A is a sub-alignment film, 106B is also a sub-alignment film, 100 is a liquid crystal unit corresponding to the respective pixel, 100A is a sub-liquid crystal unit, and 100B is also a sub-liquid crystal unit. 103A1 is a liquid crystal molecule, 103A9 is also a liquid crystal molecule, 103B1 is also a liquid crystal molecule, and 103B9 is also a liquid crystal molecule. 104 is an alignment film, 104A is a sub-alignment film, and 104B is also a sub-alignment film. 105 is a polarizer. 111 is an arrow indicating a direction of the transmission axis of the polarizer 107, 108A is an arrow illustrating the orientation direction applied to the sub-alignment film 106A, 108B is an arrow illustrating the orientation direction applied to the sub-alignment film 106B, 101A is an arrow illustrating the orientation direction applied to the sub-alignment film 104A, 101B is an arrow illustrating the orientation direction applied to the sub-alignment film 104B, 110 is an arrow indicating a direction of the transmission axis of the polarizer 105. The difference between the directions of the arrow 101A and arrow 101B is about 180 degrees. In addition, in consider of the pre-incline direction of the liquid crystal molecule, the direction of the head portion of the arrow indicating the orientation direction indicates the upright direction of the liquid crystal molecule. The difference between the directions of the arrow 108A and arrow 108B is also about 180 degrees. In other words, the arrows 108A and 108B are in a symmetry relationship.

Additionally, the difference between the arrows 111 and 110 indicating the directions of the transmission axes of the two polarizers is about 90 degrees, and the transmission axes of the two polarizers are almost at an orthogonal state.

Furthermore, the “orientation region” described in the present invention is referred to as a region where a pixel is divided into two, and the “sub-liquid crystal unit” and “sub-alignment film” exist in the respective region.

The liquid crystal unit 100 is composed of a sub-liquid crystal unit 100A and a sub-liquid crystal unit 100B. And the alignment film 104 is also composed of a sub-alignment film 104A and a sub-alignment film 104B. Similarly, the alignment film 106 is also composed of a sub-alignment film 106A and a sub-alignment film 106B. The liquid crystal molecule 103A1 is the liquid crystal molecule, which is located at the lower most position in the sub-liquid crystal unit 100A, is adjacent to the sub-alignment film 104A, and is oriented in a direction that is the same as the direction of the arrow 101A. Similarly, the liquid crystal molecule 103B1 is the liquid crystal molecule which is located at the lower most position in the sub-liquid crystal unit 100B, is adjacent to the sub-alignment film 104B, and is oriented at a direction that is the same as the direction of the arrow 101B.

The liquid crystal molecule 103A9 is a liquid crystal molecule which is located at the upper most position in the sub-liquid crystal unit 100A, is adjacent to the sub-alignment film 106A, and is oriented at a direction which is the same as the direction of the arrow 108A. Similarly, the liquid crystal molecule 103B9 is a liquid crystal molecule which is located at the upper most position in the sub-liquid crystal unit 100B, is adjacent to the sub-alignment film 106B, and is oriented in a direction which is the same as the direction of the arrow 108B.

Next, the pixel at the sub-liquid crystal unit 100A side will be described firstly.

The liquid crystal molecules existing between the liquid crystal molecule 103A1 and 103A9 have their orientation twisted in turn from the direction of the liquid crystal molecule 103A1 to the direction of the liquid crystal molecule 103A9.

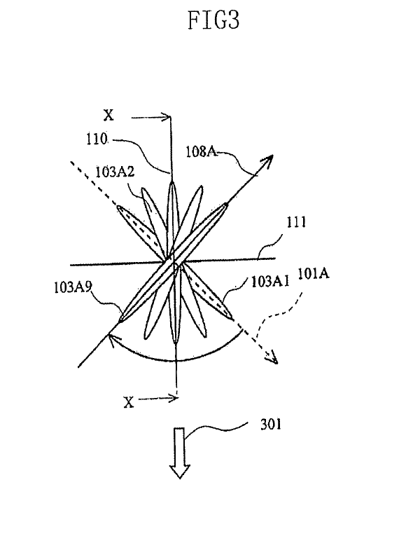

FIG. 3 is a plan view illustrating that the liquid crystal molecule 103A1, liquid crystal molecule 103A9, and the liquid crystal molecules between the liquid crystal molecule 103A1 to 103A9 existing in the sub-liquid crystal unit 100A have their orientation twisted in turn under a condition that the voltage is not applied to the sub-liquid crystal unit 100A.

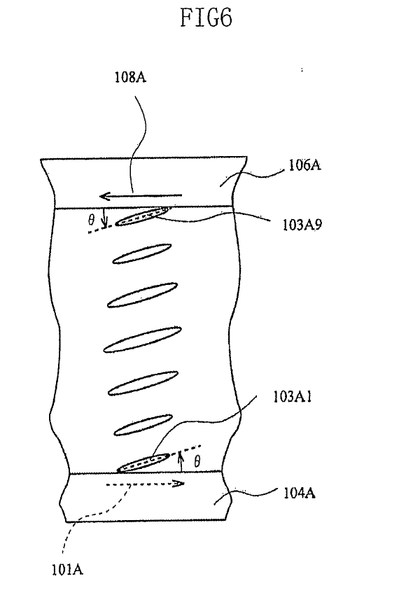

Furthermore, FIG. 6 is a cross sectional view taken along the line X-X in FIG. 3, illustrating that the liquid crystal molecule 103A1, liquid crystal molecule 103A9, and the liquid crystal molecules between the liquid crystal molecule 103A1 to 103A9 existing in the sub-liquid crystal unit 100A have their orientation twisted in turn under a condition that the voltage is not applied to the sub-liquid crystal unit 100A is observed transversely. In FIG. 6, θ is a pretilt angle. Furthermore, in FIG. 3, 103A1 is the liquid crystal molecule, which is adjacent to the sub-alignment film 104A, and 103A9 is the liquid crystal molecule, which is adjacent to the sub-alignment film 106A. While 101A is an arrow, which indicates the orientation direction, that is, the orientation direction of the sub-alignment film 104A, and 108A is an arrow which indicates the orientation direction, that is, the orientation direction of the sub-alignment film 106A. 103A2 is a liquid crystal molecule located between the liquid crystal molecules 103A1 and 103A9, and which is oriented in a direction between the liquid crystal molecules 103A1 and 103A9. While 110 is an arrow indicating the direction of transmission axis of the polarizer 105, and 111 is an arrow indicating the direction of the transmission axis of the polarizer 107. 301 is a hollow arrow indicating an intermediate direction between the orientation direction of the liquid crystal molecule 103A1 and the orientation direction of the liquid crystal molecule 103A9.

Furthermore, a glass substrate (not shown) exists between the polarizer 107 and the alignment film 106. Similarly, there is also a glass substrate (not shown) between the polarizer 105 and the alignment film 104.

The function and the effect of the pixel in the embodiment of the present invention as shown in FIG. 1 will be described as follows.

Under a condition that the voltage is not applied to the sub-liquid crystal unit 100A, the liquid crystal molecule 103A1 adjacent to the alignment film 104A is subjected to an oriented restriction force from the alignment film 104A, and the long axis direction of the liquid crystal molecule is oriented at a direction that is the same as the orientation direction of the alignment film 104A under a state that the front end of the liquid crystal molecule is risen by a pretilt angle of θ. That is, it is oriented in a direction, which is the same as the orientation direction indicated by the arrow 101A. Similarly, the liquid crystal molecule 103A9 adjacent to the alignment film 106A is oriented at a direction that is the same as the orientation direction of the alignment film 106A. That is, it is oriented at a direction, which is the same as the orientation direction indicated by the arrow 108A. Furthermore, the liquid crystal molecules existing between the liquid crystal 103A1 to liquid crystal molecule 103A9 are oriented in turn from the orientation direction of the liquid crystal molecule 103A1 to the orientation direction of the liquid crystal molecule 103A9 as shown in FIG. 3. FIG. 6 is a cross sectional view taken along the line X-X in FIG. 3.

Under this condition, as shown in FIG. 3, it is twisted about 90 degrees from the direction of the orientation direction of the liquid crystal molecule 103A1 to the direction of the orientation direction of the liquid crystal molecule 103A9, therefore, the incident light from the polarizer 105 is twisted about 90 degrees and then passes through the polarizer 107 to form bright display.

The dark display will be described as follows. In order to perform the dark display, sufficient voltage is applied to the sub-liquid crystal unit 100A.

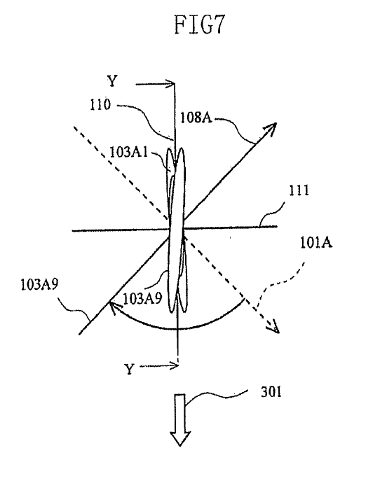

FIG. 7 is a plan view illustrating the liquid crystal molecules alignment state under a condition that sufficient voltage is applied to the sub-liquid crystal unit 100A.

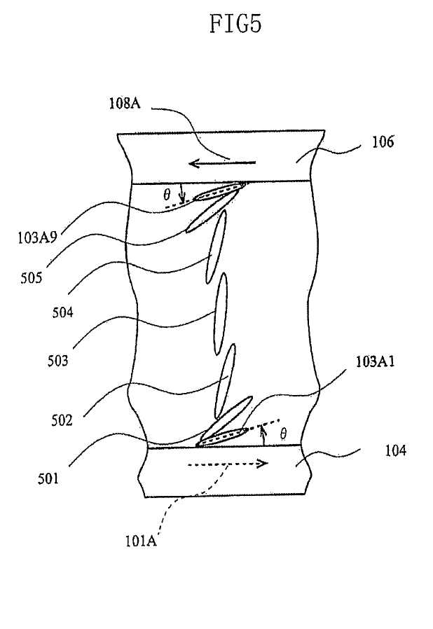

FIG. 5 is a cross sectional view taken along the line Y-Y in FIG. 7 illustrating the liquid crystal molecules alignment state when sufficient voltage is applied to the sub-liquid crystal unit 100A. In FIG. 5, 501 to 505 are liquid crystal molecules. When sufficient voltage is applied to the sub-liquid crystal unit 100A, the liquid crystal molecules are oriented along the direction of the electrical field as shown in FIG. 5. The liquid crystal molecules at the intermediate position of the thickness direction of the liquid crystal layer of the sub-liquid crystal unit 100A are substantially oriented vertically. However, the liquid crystal molecules, such as the liquid crystal molecules 103A1 and 103A9, which are located near the alignment films 104A and 106A, cannot be upright sufficiently because of the anchoring effect produced by the alignment films 104A and 106A and can maintain a pretilt angle θ, meanwhile, the long axis direction of the liquid crystal molecule is oriented in an overlapping state as shown in FIG. 7 at an intermediate angle between the orientation direction 101A applied to the alignment film 104A and the orientation direction 108A applied to the alignment film 106A. The direction of the intermediate angle is the same as the direction as shown by the hollow arrow 301 shown in FIG. 7.

As it can be understood from FIG. 7, the direction of the hollow arrow 301 and the direction 110 of the transmission axis of the polarizer 105 are in parallel. When the overlapping direction of the liquid crystal molecules and the transmission axis direction 110 of the polarizer 105 are in parallel, for the incident light from the polarizer 105, the direction of the vibration plane will not be changed by the existence of the liquid crystal molecules. And because the liquid crystal molecules existing in the regions which are not adjacent to the alignment film are substantially upright along the electrical field, so the vibration plane of the light will not be changed due to the existence of these liquid crystal molecules. Therefore, for the light incident to the liquid crystal and transmitting through the polarizer 105, the vibration plane of the light maintains in a direction which is the same as the direction 110 of the transmission axis of the polarizer 105 and reaches the polarizer 107. Herein, because the direction 110 of the transmission axis of the polarizer 105 and the direction 111 of the transmission axis of the polarizer 107 form an angle of 90 degrees, therefore, the vibration plane of the light reaching the polarizer 107 and the direction 111 of the transmission axis of the polarizer 107 also form an angle of 90 degrees, so that it cannot transmit through the polarizer 107. As a result, an ideal dark display can be achieved.

A prior pixel applied similarly sufficient voltage will be described as follows. When sufficient voltage is applied to the prior pixel, the liquid crystal molecules located at the middle of the direction of the thickness of the liquid crystal layer are oriented vertically, which is the same as that in the present invention. Furthermore, the feature that the liquid crystal molecules adjacent the alignment films are oriented in a direction which is in the middle of an angle formed by the orientation directions of the upper and lower alignment films having a orientation direction difference of 90 degrees is also the same.

However, a direction of an angle of 45 degrees which is at the middle of the angle of 90 degrees formed by the orientation directions applied on the upper and lower alignment films is the same as the transmission axis direction of the polarizer in the present invention, but under the condition of a prior pixel, an angle of 45 degrees is formed between the direction in the middle of the angle formed by the upper and lower alignment films and the transmission axis direction of the polarizer.

As a result, because the liquid crystal molecules adjacent the alignment film are oriented at a direction which has a 45 degree angle with respect to the transmission axis of the polarizer, so the light incident to the liquid crystal from a polarizer is polarized due to the liquid crystal molecule. Because the light is polarized, so the light is transmitted through another polarizer, whose polarization plane has a difference of 90 degrees, therefore, excellent dark display cannot be achieved.

As a result, for the prior pixels, even though under a condition that sufficient voltage is applied, the liquid crystal molecules adjacent the alignment film is not upright entirely, which causes the deterioration of the contrast.

On the other hand, for the pixels of the present invention, even though under a condition that sufficient voltage is applied, the liquid crystal molecules adjacent the alignment film are not upright entirely, this feature is the same as that of the prior art, however, because the liquid crystal molecules adjacent the alignment film are oriented at a direction as same as that of the transmission axis of the polarizer, so the deterioration of the contrast does not occur and it can realize the high contrast.

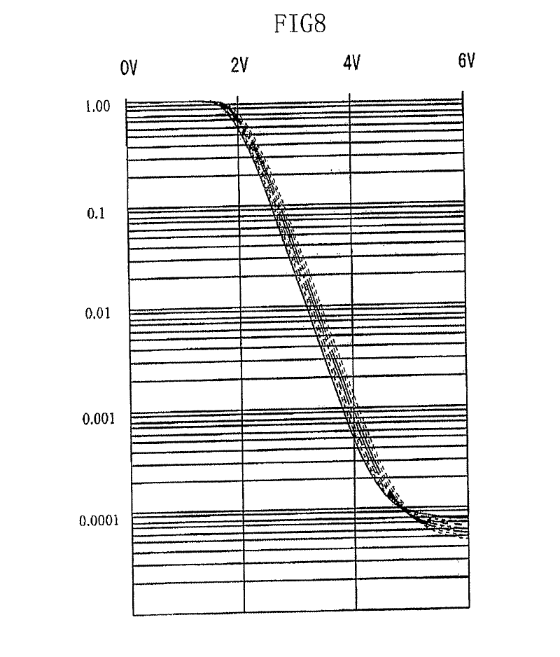

FIG. 8 is a graph illustrating the relationship between the voltage applied to the pixels of the liquid crystal panel and the transmissivity of the light in an embodiment of the present invention.

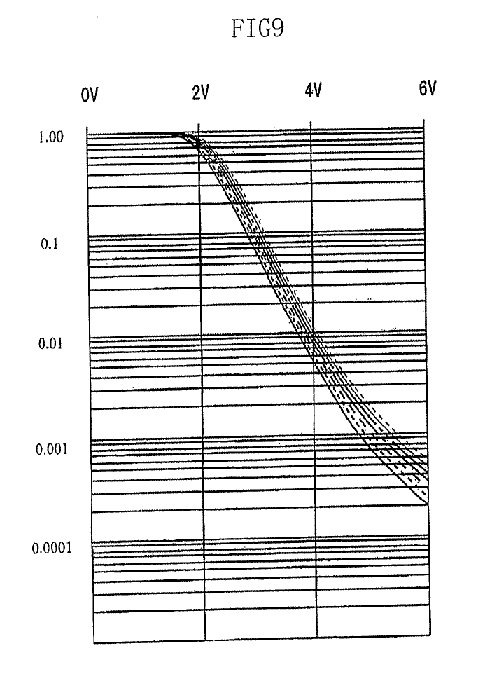

FIG. 9 is a graph illustrating the voltage applied to the pixels of the liquid crystal panel and the transmissivity of the light in prior TN liquid crystal.

In FIG. 8 and FIG. 9, the vertical axis is the transmissivity of the light, and the horizontal axis is the voltage (Volts) applied to the liquid crystal.

As shown in FIG. 8, the voltage applied is about 4.5V, and the transmissivity of the light is about 0.02%. By comparing, the voltage applied as shown in FIG. 9 is about 4.5V, and the transmissivity of the light is about 0.2%. Both of the transmissivity of the light are the same under the condition that the voltage is not applied, therefore the contrasts are different with each other by 10 times.

The sub-liquid crystal unit 100B side will be described as follows. The difference between the sub-liquid crystal unit 100B side and the sub-liquid crystal unit 100A side is that the difference between the orientation direction applied to the sub-alignment film 106B and the orientation direction applied to the sub-alignment film 106A is about 180 degrees, and the difference between the orientation direction applied to the sub-alignment film 104B and the orientation direction applied to the sub-alignment film 104A is also about 180 degrees, as a result, a symmetry relationship is formed between the orientation direction of the liquid crystal molecules in the sub-liquid crystal unit 100B and the liquid crystal molecules in the sub-liquid crystal unit 100A.

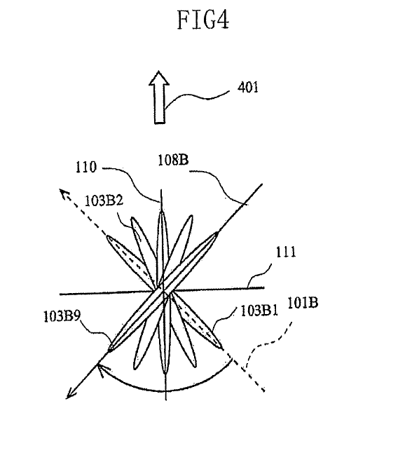

FIG. 4 is a plan view illustrating that the liquid crystal molecule 103B1, liquid crystal molecule 103B9, and the liquid crystal molecules between the liquid crystal molecule 103B1 to 103B9 existing in the sub-liquid crystal unit 100B are twistingly oriented in turn under a condition that the voltage is not applied to the sub-liquid crystal unit 100B.

In FIG. 4, 103B1 is the liquid crystal molecule adjacent to the sub-alignment film 104B; 103B9 is the liquid crystal molecule adjacent to the sub-alignment film 106B. Furthermore, 100B is an arrow indicating an orientation direction applied to the sub-alignment film 104B, 108B is an arrow indicating an orientation direction applied to the sub-alignment film 106B. 103B2 is the liquid crystal molecules located between the liquid crystal molecules 103B1 and 103B9, and is oriented in a direction between the liquid crystal molecules 103B1 and 103B9. While 110 is an arrow indicating the transmission axis of the polarizer 105, and 111 is an arrow indicating the transmission axis of the polarizer 107. 401 is a hollow arrow indicating an intermediate direction between the orientation direction of the liquid crystal molecule 103B1 and the orientation direction of the liquid crystal molecule 103B9.

For the sub-liquid crystal unit 100B side, also under the condition that the voltage is not applied to the sub-liquid crystal unit 100B, as shown in FIG. 4, the liquid crystal molecules are twistingly orientated from the orientation direction of the liquid crystal molecule 103B1 to the orientation direction of the liquid crystal molecule 103B9 about 90 degrees. Therefore, the light incident from the polarizer 105 is twisted about 90°, and then passes through the polarizer 107 to form bright display. This is the same as that at the sub-liquid crystal unit 100A side.

Furthermore, when sufficient voltage is applied to the sub-liquid crystal unit 100B, then it is the same as the condition that the voltage is applied to the sub-liquid crystal unit 100A, the liquid crystal molecules are aligned along the electrical field.

The sub-liquid crystal unit 100B side differs from the sub-liquid crystal unit 100A side in that the difference between the orientation directions applied to the sub-alignment film 104B and the orientation direction applied to the sub-alignment film 104A is about 180 degrees to form symmetry, thus, symmetry is also formed in the direction that the excellent contrast can be obtained.

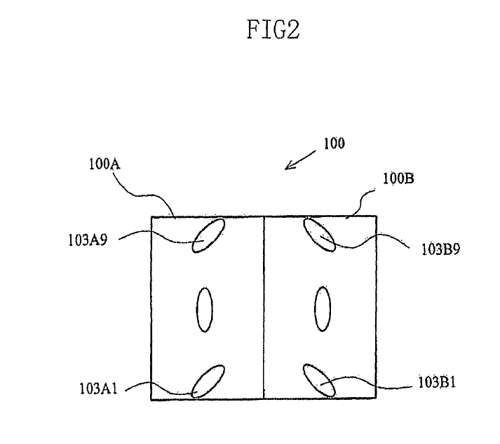

FIG. 2 is a cross sectional view illustrating schematically an alignment state of the liquid crystal molecules when the voltage is applied to a sub-liquid crystal unit 100B and a sub-liquid crystal unit 100A.

As shown in FIG. 2, the liquid crystal molecules in the sub-liquid crystal unit 100B and the liquid crystal molecules in the sub-liquid crystal unit 100A are aligned symmetrically along the orientation direction.

As a result, the directions in which the grey scale reversion occurs are also symmetrical at the sub-liquid crystal unit 100B side and the sub-liquid crystal unit 100A side. Therefore, the sub-liquid crystal unit 100B side and the sub-liquid crystal unit 100A side supplement with each other for the contrast and the grey scale reversion.

As a result, the contrast and the visual characteristic will be improved if the pixel of the present invention is used.

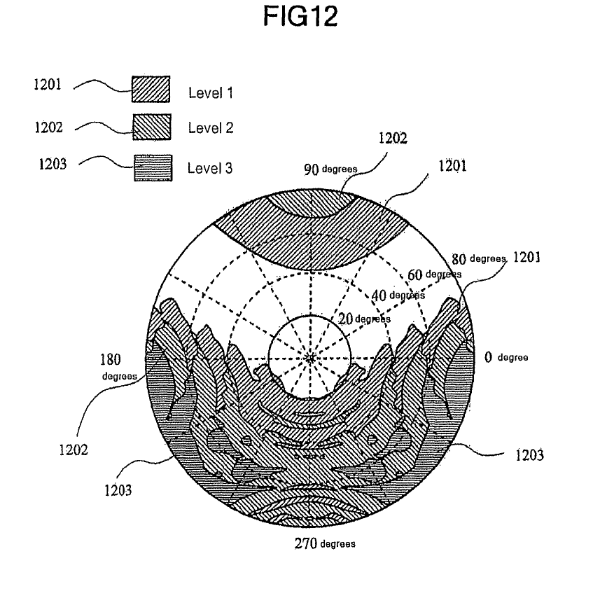

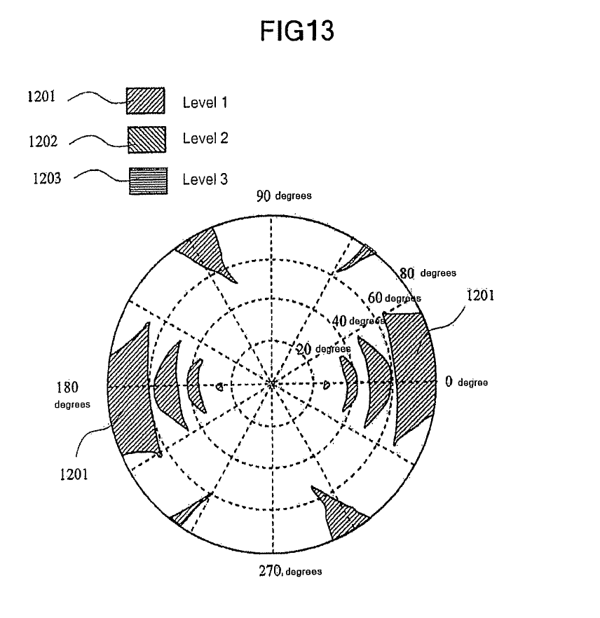

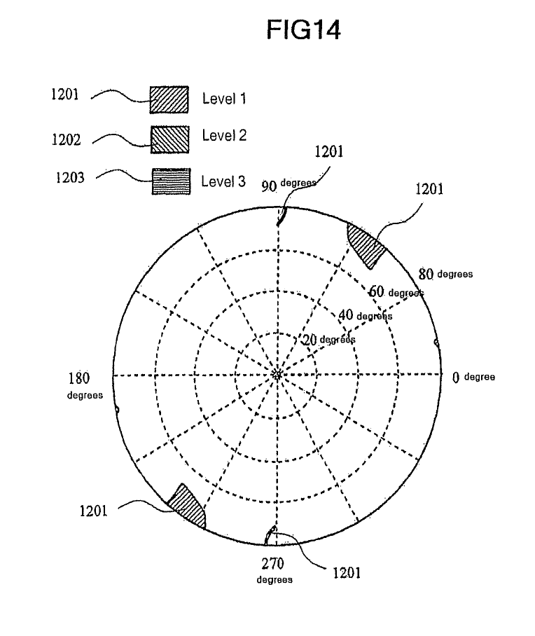

FIG. 12 is a graph illustrating the viewing angle characteristic of a liquid crystal panel having the prior pixel structure (TN liquid crystal). FIG. 13 is a graph illustrating the viewing angle characteristic of a liquid crystal panel which is a liquid crystal panel having the prior pixel structure (TN liquid crystal) after being improved by utilizing a phase compensation film. FIG. 14 is a graph illustrating the viewing angle characteristic of a liquid crystal panel having the pixel structure of the present invention.

In FIG. 12, 1201 to 1203 indicate the viewing angle regions in which the grey scale reversion takes places. On this point, it is the same as that in FIG. 13, and FIG. 14.

FIG. 12 is a graph illustrating the corresponding relationship between the observed bearing among the entire bearings and the grey scale reversion when the picture is observed, the direction recorded as “90 degrees” in the drawing corresponds to the picture which is viewed from above, in other words, it is a condition viewed from the direction of twelve o'clock of a clock, the direction recorded as “180 degrees” corresponds to the picture which is viewed from left, in other words, it is a condition viewed from the direction of nine o'clock of a clock, the direction recorded as “270 degrees” corresponds to the picture which is viewed from below, in other words, it is a condition viewed from the direction of six o'clock of a clock, and the direction recorded as “0 degree” corresponds to the picture which is viewed from right, in other words, it is a condition viewed from the direction of three o'clock of a clock. Furthermore, the “the amount of the degrees” recorded near the concentric circles within the curves indicates the angle from a direction which is perpendicular with the picture to a direction which is in the horizontal direction, the outer the concentric circles is located, the larger the angle from the vertical direction to the horizontal direction is. This is also the same as that in FIG. 13, FIG. 14.

Furthermore, in FIG. 12, 1201 to 1203 indicate the bearings where the grey scale reversions occur and the degree of the grey scale reversion.

As shown in FIG. 12, in the prior pixel structure (TN liquid crystal), under a condition that the observation is performed from above, left and right, and then below, the grey scale reversion occurs in a wide range so that the characteristic of the viewing angle is not good.

Furthermore, as shown in FIG. 13, under a condition that the prior pixel structure (TN liquid crystal) is improved by utilizing the phase compensation film, and under a condition that the observation is performed from the upper and lower direction, the grey scale reversion almost does not occur, however, when it is observed from left and right, the grey scale reversion occurs to a certain extent.

Comparing with these conditions, as shown in FIG. 14, under a condition of the pixel of the present invention, the grey scale reversion almost does not occur at the entire bearings, and it can obtain very excellent viewing angle characteristic, each liquid crystal unit of the respective pixels compensates the viewing angle characteristic for each other.

Further, the method for manufacturing the liquid crystal panel having the pixel structure of the embodiment of the present invention is the same as the method for manufacturing the prior liquid crystal panel, the only difference is that the pixels in the present invention are divided into two regions, and have the orientation direction difference of 180 degrees with each other. This can be achieved by forming the orientation directions with difference of about 180 degrees on the alignment films corresponding to the respective pixels. In order to obtain the orientation directions having difference of about 180 degrees with each other, the orientation is performed twice when the alignment film is oriented, and a mask is used for the respective orientation, and the orientation is performed at the directions having the difference of 180 degrees. It will be described by referring to the drawings as follows.

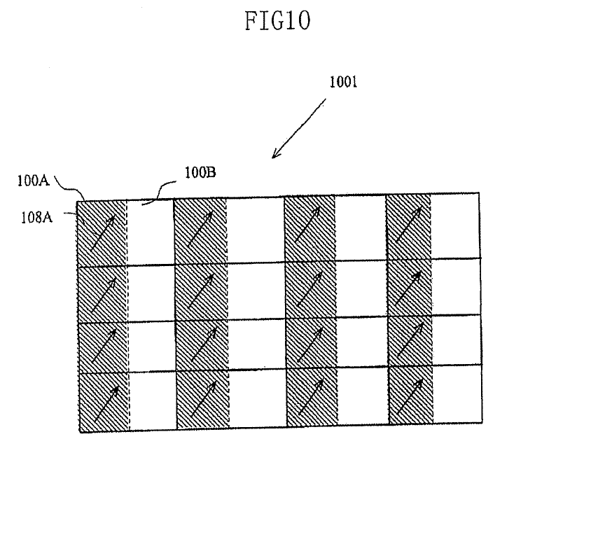

FIG. 10 is an illustration view for describing a general condition of a mask which is used under a condition that the orientation is performed on the alignment film at the sub-liquid crystal unit 100A side of the alignment film 106.

In FIG. 10, 1001 is a mask being used when the orientation is performed on the alignment film at the sub-liquid crystal unit 100A side of the alignment film 106, and a range having diagonal lines indicates an opening.

In order to obtain the orientation at the sub-liquid crystal unit 100A side, the orientation is performed on the alignment film 106 along an arrow 108A by using the mask 1001.

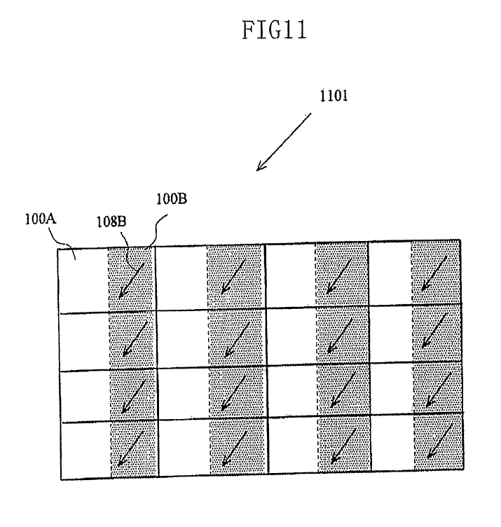

FIG. 11 is an illustration view for describing a general condition of a mask which is used under a condition that the orientation is performed on the alignment film at the sub-liquid crystal unit 100B side of the alignment film 106.

In FIG. 11, 1101 is a mask being used when the orientation is performed on the alignment film at the sub-liquid crystal unit 100B side of the alignment film 106, and a range having black dots indicates an opening.

In order to obtain the orientation at the sub-liquid crystal unit 100B side, the orientation is performed on the alignment film 106 along an arrow 108B by using the mask 1101. Further, the same mask can also be used to form the orientation under irradiating the light.

What is claimed is:

1. A liquid crystal panel for an active matrix type liquid crystal display device, wherein the following structure is formed, that is,
each of the pixels of said liquid crystal panel comprises a liquid crystal layer, wherein said liquid crystal layer comprises a first orientation region in a first liquid crystal orientation direction and a second orientation region in a second liquid crystal orientation direction,
the difference between said first liquid crystal orientation direction and said second liquid crystal orientation direction is about 180 degrees,
the transmission axes of two polarizers, between which said liquid crystal layer is sandwiched, are perpendicular with each other, and angles of about 45 degrees are formed by the transmission axes of the polarizers together with said first orientation direction and said second orientation direction.

2. The liquid crystal panel of an active matrix type liquid crystal display device as claimed in claim 1, wherein said liquid crystal layer is in a twisted nematic liquid crystal mode.

3. An active matrix type liquid crystal display device, wherein the active matrix type liquid crystal display device comprises the liquid crystal panel as claimed in claim 1.

4. The active matrix type liquid crystal display device as claimed in claim 3, wherein said liquid crystal layer is in a twisted nematic liquid crystal mode.
